(19) United States
(12) Patent Application Publication
(10) Pub. No.: US 2026/0293912 A1
(43) Pub. Date: Oct. 1, 2026

(54) COMPOSITION FOR GROWTH MEDIA AND/OR CROP SOLUTIONS AND/OR PLANTS

(71) Applicant: AGRO INNOVATION INTERNATIONAL, Saint-Malo (FR)

(72) Inventors: Sylvain PLUCHON, Saint-Malo (FR); Cécile LE GUILLARD, Saint-Malo (FR); Florence CRUZ, Saint-Malo (FR); Quentin DROGUE, Saint-Malo (FR); Rozenn TREPOS, Saint-Malo (FR)

(21) Appl. No.: 19/482,609

(22) PCT Filed: May 6, 2024
(86) PCT No.: PCT/FR2024/050592

§ 371 Date: Nov. 7, 2025

(30) Foreign Application Priority Data
May 10, 2023 (FR) FR2304640

(51) Int. Cl. A01N 65/03; A01N 37/36; A01N 43/16; A01N 59/06; A01P 21/00

(52) U.S. Cl. CPC A01N 65/03; A01N 37/36; A01N 43/16; A01N 59/06; A01P 21/00

(57) ABSTRACT

The present invention relates to a composition for growth media and/or crop solutions and/or plants comprising the combination of: —a carboxylic acid, —a polysaccharide, —calcium, and —a microalgae. The invention additionally relates to the use of the composition according to the invention, to promote the formation of bacterial biofilms and/or the maturation thereof on the growth medium, the rhizosphere and/or the roots of a plant.

### TECHNICAL FIELD

The present invention relates to the field of compositions intended for plants and/or soil having a beneficial effect thereon. It relates in particular to a composition based on microalgae, an organic fraction and a mineral fraction to promote the formation of bacterial biofilms.

### PRIOR ART

Soil is an active, living, dynamic, and biodiverse ecosystem on Earth. It is home to thousands of prokaryotic and eukaryotic life forms. The responses of the microbial community are influenced by the surrounding soil environment. As a natural resource, soil plays a vital role in biodiversity and contributes to many other ecosystem services. Soil is said to be prolific due to the activity of microorganisms at an adequate rate for optimal plant development and growth. Even though they are abundantly present, soil nutrients and other essential elements are poorly available to plants. Through various (physical, chemical, and biological) processes, root-associated microorganisms play a major role in soil formation and fertility.

Thus, a wide variety of microorganisms and macroorganisms exist in symbiosis in the rhizosphere. Bacteria are the most predominant.

Conventionally, bacterial cells have been identified and characterized as individual cells evolving independently among other cells. However, in nature, >90% of bacterial biomass grows as biofilm.

A biofilm is defined as an aggregate of microorganisms whose cells are enclosed in a matrix of extracellular polymeric substance (EPS) adhering to each other and/or to a surface (IUPAC).

Biofilm formation is a complex process involving several steps:
i. Attachment of planktonic bacteria to the biotic or abiotic surface by chemotaxis processes,
ii. Cell adhesion and loss of motility,
iii. Production of exopolymers (EPS),
iv. Biofilm maturation phases where biofilm architecture and primary microcolonies develop by the process of Quorum Sensing (QS),
v. Dispersion phase: planktonic cells disperse from the microcolonies by the process of Quorum Quenching (QQ).

The biofilm represents a form of bacterial resistance compared to planktonic (that is to say, free-living and isolated) forms. In the medical field, strategies for combating pathogens target biofilms. Conversely, and surprisingly, biofilms are of major interest in agriculture and plant growth and nutrition. It is therefore necessary to seek to stimulate their formation, particularly in the soil and on root surfaces.

The biofilm provides benefits for both plants and soil. For plants, they promote the benefits of PGPR1 (Plant Growth Promoting Rhizobacteria) organisms. Biofilms near root systems increase stress tolerance (biotic and abiotic). Extracellular polymeric substances play a central role in nutrient availability (nitrogen, phosphorus, etc.). For example, the establishment of a symbiosis between nitrogen-fixing rhizobia and plants.

For soil, biofilm stabilizes the environment for microorganism development, acting as a carbon and nutrient reserve. It provides protection against desiccation and promotes aggregation and adhesion. Microbial activity is increased tenfold within biofilms.

The inventors surprisingly discovered that the combination of microalgae with a carboxylic acid, a polysaccharide and calcium allowed to promote the formation of bacterial biofilms and/or their maturation in the soil, the rhizosphere and/or the roots of a plant.

### DISCLOSURE OF THE INVENTION

The present invention relates to a composition for growth media and/or crop solutions and/or plants comprising the combination of:
a carboxylic acid, advantageously in a content comprised between 1% and 5% by weight relative to the total weight of the combination,
a polysaccharide, advantageously in a content comprised between 15% and 27% by weight relative to the total weight of the combination,
calcium, advantageously in a content comprised between 43% and 69% by weight relative to the total weight of the combination, and
a microalgae, advantageously in the form of an extract, more advantageously in a content comprised between 15% and 25% by weight relative to the total weight of the combination.

For the purposes of the present invention, the term “composition for growth media and/or crop solutions and/or plants” means a composition intended to be administered to growth media and/or crop solutions and/or to plants, in particular cultivated plants, in order to provide them with a benefit. Advantageously, this composition is acceptable in phytosanitary terms.

For the purposes of the present invention, the term “acceptable in phytosanitary terms” means that it is acceptable for use on plants or growth media and/or crop solutions, that is to say non-polluting for the environment and non-toxic for humans (users).

For the purposes of the present invention, the term “growth medium” means any soil or medium on which a crop can grow, such as, for example, artificial soil, cultivated agricultural soil, uncultivated agricultural soil, peat, compost, rock wool or coconut fiber.

For the purposes of the present invention, the term “crop solution” means any solution which allows the cultivation of a plant such as, for example, irrigation water, liquid solution intended for fertigation by sprinkling or drip irrigation, hydroponic bath or aeroponic solution.

The expression “plant” is intended to designate in this application the plant considered as a whole, including its root system, its vegetative system, the seeds, grains and fruits.

The plants according to the invention may be selected from field crops such as cereals (wheat, corn, barley), protein crops (peas), oilseeds (soybean, sunflower), Solanaceae crops (potato), Amaranthaceae crops (beetroot), specialized crops such as in particular market gardening (lettuce, spinach, onion, shallot, tomato, melon), vines, arboriculture (pear, apple, nectarine), or horticulture. In particular, the plant may belong to the order of monocotyledons, preferably to the Poaceae family. Poaceae, commonly called grasses, include in particular most of the species commonly called “green plants” and “cereals”. Among the Poaceae, mention may be made of wheat, rice, barley, oats, rye, sugar cane, meadow and corn.

Legumes belong to the Fabaceae family. Legumes play an important role in the food sector due to their high protein and essential amino acid content. Examples of leguminous plants, but without limitation, are soybeans, peanuts, beans, peas, in particular of the species P. sativum, lentils, chickpeas, broad beans, field beans, vetches, grass vetch, alfalfa, clover, lupin, mung beans (germinated soybean sprouts), licorice, rosewood, birdsfoot trefoil, sainfoin, rooibos, and fenugreek.

The composition according to the invention therefore comprises the combination of a carboxylic acid, a polysaccharide, calcium, and a microalgae.

The term “carboxylic acid” must be understood in its common sense, that is to say an acid of formula R—COOH, where R is hydrogen or an organic group, advantageously R is an organic group comprising between 1 and 10 carbon atoms. The carboxylic acid that can be used in the combination according to the invention may be a monocarboxylic acid or a polycarboxylic acid, advantageously tricarboxylic. Advantageously, it is a weak acid, in particular an organic acid. In the context of the present invention, the carboxylic acid may be selected from methanoic acid, ethanoic acid, acetic acid, propanoic acid, butanoic acid, pentanoic acid, hexanoic acid, heptanoic acid, octanoic acid, nonanoic acid, decanoic acid, benzoic acid, 2-hydroxybenzoic acid, 2-mercaptopropanoic acid. In a preferred embodiment, the carboxylic acid is selected from formic acid, acetic acid, lactic acid, citric acid, oxalic acid, propionic acid, malic acid, tartaric acid, fumaric acid, gluconic acid, sorbic acid and butyric acid, preferably the carboxylic acid is selected from formic acid, citric acid, acetic acid and lactic acid. In a particularly preferred embodiment, the carboxylic acid is citric acid.

Advantageously, the carboxylic acid is present in the combination in a content comprised between 1% and 5% by weight, advantageously between 2% and 4% by weight, more advantageously between 3% and 4% by weight, in particular between 3% and 3.5% by weight, more particularly in a content of 3.3% by weight, relative to the total weight of the combination.

In the context of the present invention, the carboxylic acid allows to promote the formation of EPS in synergy with the calcium of the combination according to the invention.

In the context of the present invention the terms “comprised between . . . and . . . ” and “from to . . . ” mean that the limits of the range are included.

For the purposes of the present invention, the term “polysaccharide” means any polymer of the carbohydrate family consisting of several oses bound together by osidic bonds. It may be a homopolysaccharide (consisting of the same monosaccharide) or a heteropolysaccharide (formed of different monosaccharides). Advantageously, it is a heteropolysaccharide, more advantageously of plant origin, even more advantageously with a linear chain. The polysaccharide that can be used in the context of the present invention may be selected from starch, inulin, cellulose and a pectin. It is advantageously a pectin, more advantageously having a degree of methylation comprised between 5% and 80%, even more advantageously comprised between 50% and 80%, more particularly comprised between 60% and 80%, even more particularly comprised between 70% and 80%, for example 71%.

Advantageously, the polysaccharide is present in the combination in a content comprised between 15% and 27% by weight, advantageously between 20% and 25% by weight, more particularly in a content of 22% by weight, relative to the total weight of the combination.

In the context of the present invention, the polysaccharide helps and promotes the formation of EPS in the biofilm.

The calcium that can be used in the context of the present invention may be a calcium salt (carbonate, citrate, malate, lactate, gluconate, etc.) or a marine calcium. Advantageously, it is a marine calcium.

For the purposes of the present invention, the term “marine calcium” means calcium derived from marine shellfish of the Maërl type. Maërl is an accumulation of coralline algae rich in limestone.

Advantageously, the calcium is present in the combination in a content comprised between 43% and 69% by weight, advantageously between 45% and 65% by weight, more advantageously between 50% and 60% by weight, in particular between 52% and 56% by weight, more particularly in a content of 54.8% by weight, relative to the total weight of the combination.

In the context of the present invention, calcium plays a role in the structuring of EPS. It acts as a binder to promote the cohesion of the biofilm.

The microalgae that can be used in the context of the present invention are advantageously eukaryotic microalgae, more advantageously selected from the group consisting of Chlorella vulgaris, Chlorella sorokiniana, Nannochloropsis sp, Skeletonema sp, Phaeodactylum sp, Dunaliella sp, Haematococcus pluvialis, Isochrysis sp and mixtures thereof, even more advantageously selected from the group consisting of Chlorella vulgaris, Chlorella sorokiniana, Isochrysis sp and mixtures thereof.

In particular, the microalgae that can be used in the context of the present invention is in the form of biomass or extract, more advantageously in the form of extract.

In the context of the present invention, microalgae is an inducer of biofilm formation (quorum sensing).

The term “extract” refers to the product resulting from an extraction from a source. For example, the source may be a biological source, such as cells. When referring to cells, the term “extract” therefore refers to the product resulting from the extraction of the contents of cells. Thus, for example, the term “microalgae extract” refers to the product resulting from the extraction of the contents of the cells of a microalgae. The extraction may be carried out with an aqueous solvent or an organic solvent, advantageously an aqueous solvent, more advantageously with water as the only solvent. In particular, the extract may be water-soluble. The extraction may be carried out by any extraction method well known to the person skilled in the art, such as hot decoction, maceration, extrusion, extraction under subcritical conditions, extraction assisted by ultrasound, with or without grinding such as grinding with ultrasound or using a mixer, advantageously by maceration. The extraction can be carried out at a temperature ranging from 4° C. to 300° C., including room temperature, that is to say a temperature of around 20° C.

Thus advantageously the microalgae extract is an extract of a eukaryotic microalgae, advantageously selected from the group consisting of Chlorella vulgaris, Chlorella sorokiniana, Nannochloropsis sp, Skeletonema sp, Phaeodactylum sp, Dunaliella sp, Haematococcus pluvialis, Isochrysis sp and mixtures thereof, more advantageously selected from the group consisting of Chlorella vulgaris, Chlorella sorokiniana, Isochrysis sp and mixtures thereof.

Advantageously, the microalgae, in particular the microalgae extract, is present in the combination in a content comprised between 15% and 25% by weight, advantageously comprised between 17% and 23% by weight, more advantageously between 18% and 22% by weight, more particularly in a content of 20% by weight, relative to the total weight of the combination.

Advantageously, the combination according to the invention is present in the composition for soils and/or plants according to the invention in a content comprised between 0.1% and 20%, in particular between 0.15% and 10%, more particularly between 0.2% and 1%, even more particularly in a content of 0.25%, by weight relative to the total weight of the composition.

The composition according to the invention may further comprise an excipient acceptable in phytosanitary terms. It may also further comprise other ingredients not forming part of the combination according to the invention. Thus the composition may comprise natural or synthetic biostimulant compounds such as amino acids, growth regulators, humic substances, plant extracts, microbial extracts, mineral materials such as nitrogen, phosphorus, potassium, molybdenum, sulfur, magnesium, iron, chlorine, manganese, zinc, boron, boric acid, disodium octaborate tetrahydrate, calcium borate, magnesium borate, sodium borosilicate, sodium tetraborate decahydrate, sodium borate, sodium tetraborate, disodium tetraborate, lime, gypsum, superphosphate, iron sulfate, iron chelate, ferritin, zinc oxide, zinc sulfate, zinc chelate, potassium nitrate, calcium nitrate, magnesium nitrate, ammonium phosphate, ammonium sulfate, magnesium sulfate, phosphate monopotassium, calcium carbonate, ammonium nitrate sulfate, ammonium thiosulfate, ammoniacal liquor, calcium cyanamide, crotonylidene diurea, diacyandiamide, isobutylidene diurea, sodium nitrate, potassium carbonate, potassium chloride, potassium magnesium sulfate, potassium metaphosphate, potassium sulfate, calcium chloride, calcium oxide, calcitic limestone, dolomitic limestone, magnesium ammonium phosphate, magnesium oxide, copper chelates, cupric ammonium phosphate, copper sulfate, copper frits, copper polyflavonoid, malachite, azurite, cuprous oxide, cupric oxide, cupric acetate, boron frits, ferric sulfate, ferrous sulfate, ferrous ammonium sulfate, ferrous ammonium phosphate, ferrous oxalate, ferrous carbonate, iron lignosulfonate, iron polyflavonoid, iron frit, iron methoxyphenylpropane, ferrous oxide, ferric oxide, iron ammonium polyphosphate, manganese oxide, manganese methoxyphenyl propane, manganese frit, manganese chloride, manganese carbonate, manganese sulfate, manganese chelate, manganese ammonium phosphate, manganese polyflavonoid, ammonium molybdate, sodium molybdate, molybdenum frit, molybdenum trioxide, molybdenum disulfide, zinc frit, zinc carbonate, zinc phosphate, zinc ammonium phosphate, zinc sulfide, zinc lignosulfonate, zinc polyflavonoid or a combination thereof and/or any excipient suitable for administration to a growth medium and/or crop solution and/or a plant.

The composition according to the invention may be in solid form, in particular in the form of powder, granules or microgranules, in the form of a liquid suspension or in the form of a gel or in water-soluble form. In particular, the composition is not lyophilized or dehydrated.

Advantageously, the composition according to the present invention may be a fertilizer, in particular a fertilizer or amendment, the fertilizer advantageously being a simple, binary or ternary solid fertilizer of the organo-mineral fertilizer or organic fertilizer type, or a water-soluble fertilizer and the amendment advantageously being an organo-mineral or organic amendment.

The term “fertilizer” means a substance, or mixture of substances, whether natural or synthetic, used in agriculture, horticulture and forestry to improve growth media, particularly their structure, and to fertilize cultivated plants. Fertilizers comprise fertilizers and amendments.

The term “fertilizer” refers to fertilizing materials whose main function is to provide plants with elements directly useful for their nutrition (major fertilizing elements, secondary fertilizing elements and trace elements).

The term “amendment” refers to a substance intended to improve the quality of growth media, and in particular intended to improve the pH of growth media. Advantageously, the amendment is selected from basic mineral amendments of the limestone and/or limestone and magnesium type; humus amendments of the compost or fertilizer type.

The present invention further relates to a growth medium comprising the composition according to the invention.

The present invention further relates to a crop solution comprising the composition according to the invention.

The present invention further relates to the use of the composition according to the invention for plants and/or growth media and/or crop solutions.

The present invention relates in particular to the use of the composition according to the invention or of the growth medium according to the invention or of the crop solution according to the invention to promote the formation of bacterial biofilms and/or the maturation thereof on the growth medium, the rhizosphere and/or the roots of a plant.

Advantageously, the use according to the invention is to improve plant growth and/or improve nutrient availability such as N-fixation or solubilization, and/or improve plant stress tolerance, such as biotic and/or abiotic stress, and/or protect growth media against desiccation and/or improve the formation and/or stability of growth medium aggregates, and/or stabilize the development environment of the microorganisms of the growth medium and/or increase the abundance and microbial activity of the growth media.

In an advantageous embodiment, the use according to the invention is by root application, open field or above ground. The composition according to the invention can be applied on the surface or mixed with the supports and/or crop solutions. In particular in the case of crop solutions it is rather a mixture. In the case of growth mediums, the composition according to the invention can be applied on the surface or mixed with the support, for example with the first layers of the support. The application can be carried out directly on the growth medium, on the entire surface of the growth medium or locally in the root region of the plants to be treated, by any suitable means of distribution, such as by spraying in the case of a liquid suspension.

Advantageously, the composition according to the invention is used by application at a concentration of 1 kilogram to 100 kilograms of the composition per hectare, in one or more times. The person skilled in the art will know how to adapt the amounts to be used depending on the chosen application method. In particular, relatively smaller amounts are used when the composition according to the invention is applied in the root region while relatively larger amounts are used when the composition is applied over the entire surface of the growth medium. The composition according to the invention can be used in a single application or in sequential application.

The application can take place before and/or during the growth of the cultivated plants, before and/or after germination of the plants, for example during transplanting in the case of plants requiring transplanting. Advantageously, it takes place after germination.

The present invention will be better understood upon reading the description of the drawings and examples which follow, which are given in an indicative non-limiting manner.

### BRIEF DESCRIPTION OF THE DRAWINGS

FIG. 1 shows the amount of biofilm obtained in mg in the presence of the compositions tested under the conditions of the example.

FIG. 2 shows the amount of wrinkles (textural nuance) in the presence (combination of the 4) and absence (control) of the combination according to the invention under the conditions of the example.

FIG. 3 shows the enlarged photograph of the presence or absence of wrinkles under the conditions of the example.

### EXAMPLE

When grown in liquid medium, Bacillus subtilis is known to produce surface films that are architecturally rich and complex. These structures are called wrinkles. They confer several advantages to biofilm development. They increase the surface-to-volume ratio, improving oxygenation. This increased surface area allows for greater aerial dispersion. The wrinkles promote the formation of a complex network of liquid channels within the biofilm, which facilitates the circulation of nutrients. This very distinct morphotype is observed when the biofilm is mature.

### Materials and Methods

### Biological Material

For the experiments, the Bacillus subtilis strain was chosen. This model was chosen because it is widely referenced as a phytobeneficial strain of type PGPR 7 (Plant Growth Promoting Rhizobacteria). This strain is referenced as a model for the study of biofilm and its ability to produce a stable and quantifiable biofilm.

### Growth Environments and Conditions

Strain conservation is carried out from fresh crop diluted with 80% glycerol (40% final) and stored at −80° C. These cryotubes serve as a starting point for all experiments, in order to prevent genetic degeneration by repeated subculturing.

In summary: Growth is conducted according to the following chronology:
i. Isolation from the cryotube;
ii. Liquid pregrowth;
iii. Growth and production of biofilm in the dish;
iv. Reading.

In detail: Cells from cryotubes are plated by quadrant method on TSA agar (Tripton: 15 g/L; soy peptone: 5 g/L; NaCl: 5 g/L; Agar: 15 g/L). The isolate is incubated at 30° C. for 24 h (precisely). At least 10 colonies are suspended in TSB medium (Tripton: 15 g/L; soy peptone: 5 g/L; NaCl: 5 g/L). The pregrowth is incubated at 30° C., 150 rpm (agitation promotes the growth of the cells in planktonic form), for 15 h (precisely). The pregrowth is calibrated (with TSB) at an OD600 nm=1 with the UV spectrophotometer (ClarioStar Plus, BMG Labtech). This inoculum is used to inoculate 1/10 (final OD600 nm=0.1) Petri dishes, previously filled with TSB medium (with or without supplementation of the products to be tested). The dishes are incubated at 30° C., without shaking, for 48 hours.

### Quantitative Analysis of Biofilm

In summary: Biofilm mass measurement is performed according to the following chronology:
i. biofilm production;
ii. Harvest;
iii. Freeze-drying;
iv. Weighing.

In detail: After growing the strain in a petri dish, a biofilm layer forms on the surface and on the walls of the dishes. The subnatant is gently removed so as not to break/remove the biofilm. The entire biofilm is harvested using a rake and transferred into a 50 ml bottle. The samples are then freeze-dried. The total dry biomass can then be measured.

### Qualitative Analysis of the Biofilm

In summary: The analysis of the quality (wrinkle production) of the biofilm is carried out according to the following chronology:
i. production of plaque biofilm;
ii. Imaging;
iii. Texture analysis.

In detail: The strain pregrowth steps are the same as for biofilm quantification. The growth step is carried out in a 24-well plate (in TSB supplemented with the products to be tested). The plate is incubated at 30° C., without shaking, for 48 hours. After biofilm production, imaging is carried out. The camera used is the Exo GigE exo138CGE camera. The camera is coupled to a V1624-MPZ lens with a focal length of 16 mm and the image is taken in the focal plane at a height of 34 cm. Subsequently, on each modality, an image extraction (representative of the sample) is carried out. A texture analysis is then carried out. The processing of the results is carried out on the “autocorrelation” and “cluster shade” data according to the method described in Haralick R M, Shanmugam K and Dinstein I (1973 Textural features for image classification IEEE Transactions on Systems, Man, and Cybernetics 3 610-21).

### Results

5 compositions were tested:
Citric acid (Sigma) at 0.08 g/L in TSB medium;
Pectin with a methylation degree of 71% (Cargill) at 0.55 g/L in TSB medium;
Marine calcium at 1.37 g/L in TSB medium;
Extract of the microalgae Isochrysis, obtained by aqueous extraction (Necton) at 0.5 g/L in TSB medium;
Combination of the 4 compounds according to the invention at 2.5 g/L in TSB medium, the combination comprising 3.3% citric acid, 22% pectin, 54.8% marine calcium and 20% microalgae extract, by weight relative to the total weight of the combination

The ability of the compounds to promote biofilm production was thus tested alone and in combination. Growth in the absence of compounds was chosen as the basal level of biofilm production (under our growth conditions).

### Biofilm Production

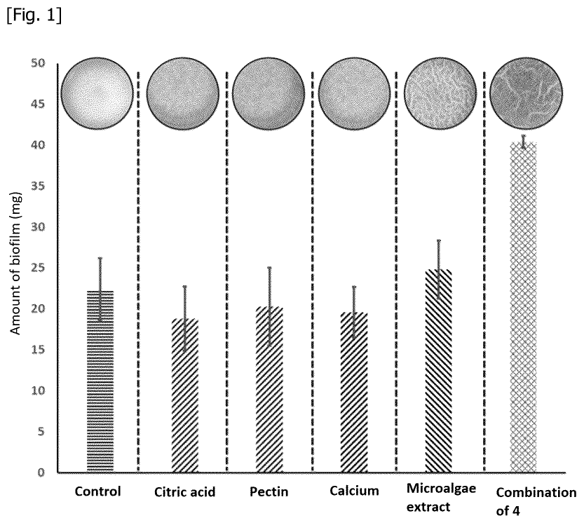

The results are shown in FIG. 1.

In the absence of the compound (Control), there is a production of 22.3±3.8 mg of biofilm. In the presence of the compounds alone there is no significant difference compared to the control. In the presence of the object of the invention there is an increase of +80% in the amount of biofilm. These data demonstrate that each compound isolated has no measurable effect on the biofilm but that the combination of the four results in a strong increase in biofilm production.

### Biofilm Maturity

The purpose of this invention is to promote both biofilm production and biofilm maturity. With the aim of producing more mature biofilm.

Growth in the absence of compounds was chosen as the basal level of biofilm production (in our growth conditions). Treatment with the combination of products was tested.

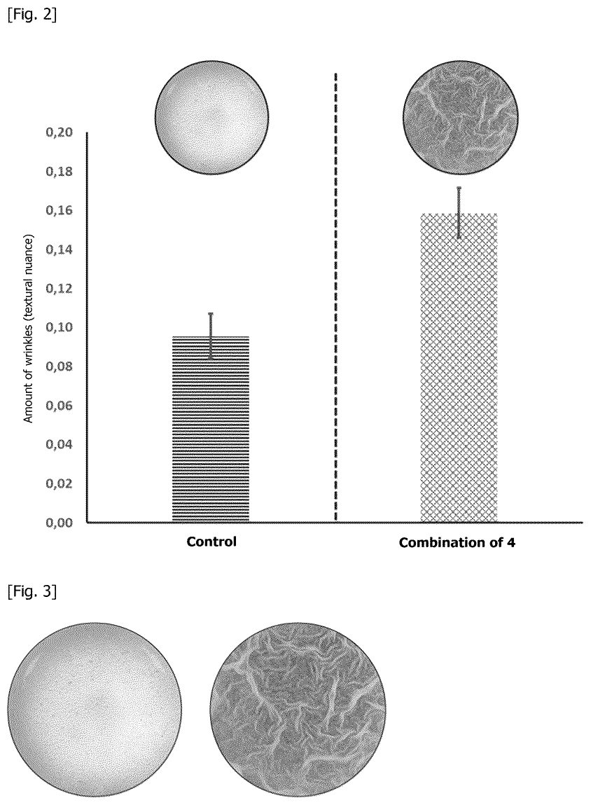

The results are presented in FIGS. 2 and 3.

Under normal growth conditions, the film formed on the surface of the growth clouds the medium, but does not form wrinkles. This results in a surface that appears homogeneous. In the presence of the combination of compounds according to the invention, a 60% increase in texture nuance is observed. These results reflect an increase in the capacity of a biofilm to mature by forming wrinkles.

The results showed that the contribution of the composition according to the invention stimulates the formation of bacterial biofilm. The morphology of the biofilm is also modified by the contribution of said composition and results in the presence of wrinkles on the surface of the biofilm. Said wrinkles increase the surface/volume ratio and allow better regulation of oxygen by the bacteria.

1. A composition for growth media and/or crop solutions and/or plants comprising the combination of:
a carboxylic acid in a content comprised between 1% and 5% by weight relative to the total weight of the combination,
a polysaccharide in a content comprised between 15% and 27% by weight relative to the total weight of the combination,
calcium in a content comprised between 43% and 69% by weight relative to the total weight of the combination, and
a microalgae in a content comprised between 15% and 25% by weight relative to the total weight of the combination.

2. The composition according to claim 1, wherein the carboxylic acid is citric acid.

3. The composition according to claim 1, wherein the polysaccharide is a pectin.

4. The composition according to claim 1, wherein the calcium is a marine calcium.

5. The composition according to claim 1, wherein the microalgae is a eukaryotic microalgae.

6. The composition according to claim 1, which further comprises an excipient acceptable in phytosanitary terms.

7. The composition according to claim 1, which is in solid form, in liquid form or in gel form.

8. The composition according to claim 1, which is a fertilizer.

9. A growth medium comprising the composition according to claim 1.

10. A crop solution comprising the composition according to claim 1.

11. A method for promoting the formation of bacterial biofilms and/or the maturation thereof on the rhizosphere and/or the roots of a plant comprising the administration to the plant of an effective amount of the composition according to claim 1 or of a growth medium comprising the composition or of a crop solution comprising the composition.

12. A method for improving plant growth and/or improving nutrient availability and/or improving plant stress tolerance and/or protecting growth media against desiccation and/or improving the formation and/or stability of growth medium aggregates, and/or stabilizing the development environment of the microorganisms of the growth medium and/or increasing the abundance and microbial activity of the growth media comprising the administration to the plant of an effective amount of the composition according to claim 1 or of a growth medium comprising the composition or of a crop solution comprising the composition.

13. The method according to claim 11, wherein the administration is by root application, open field or above ground.

14. The method according to claim 12, wherein the administration is by root application, open field or above ground.

15. The composition according to claim 1, wherein the polysaccharide is a pectin having a degree of methylation comprised between 5% and 80%.

16. The composition according to claim 1, wherein the microalgae is a eukaryotic microalgae selected from the group consisting of Chlorella vulgaris, Chlorella sorokiniana, Nannochloropsis sp, Skeletonema sp, Phaeodactylum sp, Dunaliella sp, Haematococcus pluvialis, Isochrysis sp and mixtures thereof.

17. The composition according to claim 1, wherein the microalgae is a eukaryotic microalgae selected from the group consisting of Chlorella vulgaris, Chlorella sorokiniana, Isochrysis sp and mixtures thereof.

18. The composition according to claim 1, which is a simple, binary or ternary solid fertilizer of the organo-mineral fertilizer or organic fertilizer type, or a water-soluble fertilizer.

19. The composition according to claim 1, which is an amendment.

20. The composition according to claim 1, which is an organo-mineral or organic amendment.
